(19) United States
(12) Patent Application Publication
(10) Pub. No.: US 2025/0363842 A1
(43) Pub. Date: Nov. 27, 2025

(54) METHOD, MOBILE COMMUNICATION DEVICE AND ACCESS CONTROL DEVICE FOR CONTROLLING ACCESS TO A SPACE

(71) Applicant: LEGIC Identsystems AG, Wetzikon (CH)

(72) Inventors: Michael Würth, Winterthur (CH); Remo Sennhauser, Rüti (CH)

(21) Appl. No.: 18/865,373

(22) PCT Filed: May 16, 2023
(86) PCT No.: PCT/EP2023/063080

§ 371 Date: Nov. 13, 2024

(30) Foreign Application Priority Data
May 17, 2022 (CH) CH000595/2022

(51) Int. Cl. G07C 9/00; H04W 4/80; H04W 12/037; H04W 12/08

(52) U.S. Cl. CPC G07C 9/00309; H04W 4/80; H04W 12/037; H04W 12/08; G07C 2009/00412; G07C 2009/00769

(57) ABSTRACT

A method of controlling access to a space using an access control device and a user's mobile communication device, wherein the access control device operates a Bluetooth communication circuit and transmits an advertising packet comprising a designator associated with the space, wherein the mobile communication device operates a Bluetooth communication circuit and receives the advertising packet, and wherein the mobile communication device determines whether the access control device is relevant for the user, using the designator, and access right data stored in the mobile communication device, and wherein the mobile communication device, upon determining that the access control device is relevant for the user, establishes a connection with the access control device, and wherein the mobile communication device and the access control device execute an access control protocol.

### FIELD OF THE DISCLOSURE

The present disclosure relates to a mobile communication device, an access control device and a method for controlling access to a space. Specifically, the present disclosure relates to a method of controlling access to a space using an access control device and a mobile communication device. The present disclosure further relates to a mobile communication device comprising a Bluetooth communication circuit and a processor for controlling access to a space, and an access control device comprising a Bluetooth communication circuit and a processor for controlling access to a space and to a computer program product comprising a non-transitory computer readable medium having stored thereon computer program code configured to direct a processor for controlling access to a space.

### BACKGROUND OF THE DISCLOSURE

An access system is used in buildings like hotels or office buildings to enable and restrict an access to the building or to specific areas of the building. The most basic access system is to provide a physical key-lock system to a user of the building for accessing the building. In this scenario, the user of the building receives the physical key, for example, from a reception or an employee of the building. Another access system is to provide a key card to the user of the building for accessing the building. In this scenario, the user of the building still receives the physical key card for example from a reception or an employee of the building for accessing the building. The key card comprises a digital key, which enables the access to a specific area of the building, for example, to a room or a couple of rooms or a specific floor. It is also conceivable that an elevator of the building is only usable for the user after holding the key card to a key card reader.

In another scenario, the user of the building receives the digital key via a communication network on a mobile device. In this scenario, the user does not need to go to the reception or to receive a physical key from an employee of the building. The electronic key may be directly sent to the mobile device, without the necessity of personally interacting with an employee. The specific electronic key can, for example, be used in an application of the mobile device. The application of the mobile device shows, for example, all the rooms of the building with different access requirements. The user of the mobile device can select his specific room from all of the rooms of the building. The mobile device connects with the selected room, in particular, with the selected lock of the room and the lock opens, if the key stored in the mobile device enables the entrance to this specific room. In case the stored key on the mobile device does not enable the access to the selected room, the lock remains closed and the user of the mobile device may select a different room where he may have access. The selection of the desired room requires the user to browse through all of the available rooms or areas of the building. In case the building is a large hotel with hundreds of hotel rooms, searching and finding the right room may require a sophisticated illustration, grouping and selecting process of the rooms in combination with a sophisticated user interface.

### SUMMARY OF THE DISCLOSURE

It is an object of the present disclosure to provide a method, a mobile communication device, and an access control device for controlling access to a space. In particular, it is an object of the present disclosure to provide a method, a mobile communication device and an access control device for controlling access to a space not having at least some of the disadvantages of the prior art.

According to the present disclosure, these objects are addressed by the features of the independent claims. In addition, advantageous embodiments follow from the dependent claims and the description.

According to the present disclosure, the above-mentioned objects are particularly achieved by a method for controlling access to a space using an access control device and a user's mobile communication device. The method comprises:
the access control device operating a Bluetooth communication circuit of the access control device in a peripheral role and transmitting an advertising packet, the advertising packet comprising a designator associated with the space;
the mobile communication device operating a Bluetooth communication circuit of the mobile communication device in a central role and receiving the advertising packet;
the mobile communication device determining whether the access control device is relevant for the user, using the designator, received in the advertising packet, and access right data stored in the mobile communication device;
the mobile communication device, upon determining that the access control device is relevant for the user, establishing a connection between the Bluetooth communication circuit of the mobile communication device and the Bluetooth communication circuit of the access control device; and
the mobile communication device and the access control device executing an access control protocol via the connection, executing the access control protocol including the mobile communication device transmitting access control data to the access control device, and the access control device checking permission of the user to access the space by verifying the access control data from the mobile communication device.

In an embodiment, the mobile communication device receives advertising packets from a plurality of access control devices; upon determining that more than one access control device is relevant for the user, the mobile communication device determines a selected access control device, and establishes the connection with the Bluetooth communication circuit of the selected access control device.

In an embodiment, the mobile communication device determines the selected access control device using received signal strength indicators determined for the relevant access control devices.

In an embodiment, the mobile communication device determines the selected access control device, further using transmission power levels received from the relevant access control device.

In an embodiment, the mobile communication device determines the selected access control device, using position or distance information, determined for the relevant access control devices by the mobile communication device using an ultra-wide-band transceiver.

In an embodiment, the mobile communication device determines the selected access control device by showing to the user on a display a list of relevant access control devices, and receiving from the user a selection of the selected access control device.

In an embodiment, the access control protocol is only executed, if the mobile communication device is located within a predefined distance to the relevant or selected access control device. In other words, the access control protocol is only executed, if the mobile communication device is located near enough to the relevant or selected access control device.

In an embodiment, the access control device generates a randomized designator, by applying randomization to the designator associated with the space, and/or an encrypted designator, by encrypting the designator associated with the space, and the access control device transmits the randomized and/or encrypted designator to a remote server.

In an embodiment, the access control device transmits the randomized and/or encrypted designator via the mobile communication device to the remote server. In a further embodiment, the mobile communication device uses a communication network, for example a mobile radio network, to transmit the randomized and/or encrypted designator to the remote server.

In an embodiment, the access control device functions intermittently as a beacon, operating the Bluetooth communication circuit of the access control device in a broadcaster role, and transmitting advertising packets without allowing connections; and the mobile communication device shows on a display a spatial arrangement of a plurality of access control devices functioning as beacons.

In a further aspect of the present disclosure, a mobile communication device is provided. The mobile communication device comprises a Bluetooth communication circuit and a processor connected to the Bluetooth communication circuit, the processor being configured to perform the following steps:
operating the Bluetooth communication circuit in a central role and receiving an advertising packet from an access control device controlling access to a space;
extracting from the advertising packet a designator associated with the space;
determining whether the access control device is relevant for a user of the mobile communication device, using the designator and access right data stored in the mobile communication device;
upon determining that the access control device is relevant for the user, directing the Bluetooth communication circuit to establish a connection with the access control device; and
executing an access control protocol via the connection, executing the access control protocol including the processor directing the Bluetooth communication circuit to transmit access control data to the access control device, enabling the access control device to check permission of the user to access the space.

In an embodiment, the processor is configured to receive advertising packets from a plurality of access control devices; upon determining that more than one access control device is relevant for the user, determine a selected access control device, and establish the connection with the selected access control device.

In an embodiment, the processor is configured to determine the selected access control device, using received signal strength indicators determined for the relevant access control devices.

In an embodiment, the processor is configured to determine the selected access control device, further using transmission power levels received from the relevant access control devices.

In an embodiment, the mobile communication device comprises an ultra-wide-band transceiver, and the processor is configured to determine for the relevant access control devices position or distance information, using the ultra-wide-band transceiver, and to determine the selected access control device, using the position or distance information.

In an embodiment, the processor is configured to determine the selected access control device by showing to the user on a display a list of the relevant access control devices, and receiving from the user a selection of the selected access control device.

In an embodiment, the processor is configured to receive from the access control device a randomized and/or encrypted designator associated with the space, and to transmit the randomized and/or encrypted designator securely via a mobile radio network to a remote server.

In a further aspect of the present disclosure, provided is a computer program product comprising a non-transitory computer readable medium having stored thereon computer program code. The computer program code is configured to direct a processor of a mobile communication device to perform the following steps:
operating a Bluetooth communication circuit of the mobile communication device in a central role and receiving an advertising packet from an access control device controlling access to a space;
extracting from the advertising packet a designator associated with the space;
determining whether the access control device is relevant for a user of the mobile communication device, using the designator and access right data stored in the mobile communication device;
upon determining that the access control device is relevant for the user, directing the Bluetooth communication circuit to establish a connection with the access control device; and
executing an access control protocol via the connection, executing the access control protocol including the processor directing the Bluetooth communication circuit to transmit access control data to the access control device, enabling the access control device to check permission of the user to access the space.

In an embodiment, the computer program code is further configured to direct the processor to receive advertising packets from a plurality of access control devices; upon determining that more than one access control device is relevant for the user, determine a selected access control device, and establish the connection with the selected access control device.

In an embodiment, the computer program code is further configured to direct the processor to determine the selected access control device, using received signal strength indicators determined for the relevant access control devices.

In an embodiment, the computer program code is further configured to direct the processor to determine the selected access control device, further using transmission power levels received from the relevant access control devices.

In an embodiment, the computer program code is further configured to direct the processor to determine for the relevant access control devices position or distance information, using an ultra-wide-band transceiver of the mobile communication device, and to determine the selected access control device, using the position or distance information.

In an embodiment, the computer program code is further configured to direct the processor to determine the selected access control device by showing to the user on a display a list of the relevant access control devices, and receiving from the user a selection of the selected access control device.

In an embodiment, the computer program code is further configured to direct the processor to receive from the access control device a randomized and/or encrypted designator associated with the space, and to transmit the randomized and/or encrypted designator securely via a mobile radio network to a remote server.

In a further aspect of the present disclosure, an access control device for controlling access to a space is specified. The access control device comprises a Bluetooth communication circuit and a processor connected to the Bluetooth communication circuit, the processor being configured to perform the following steps:
operating the Bluetooth communication circuit in a peripheral role and transmitting an advertising packet, the advertising packet comprising a designator associated with the space, the designator enabling a mobile communication device receiving the advertising packet to determine whether the access control device is relevant for a user of the mobile communication device;
receiving from the mobile communication device, having determined that the access control device is relevant for the user, a connection request at the Bluetooth communication circuit and directing the Bluetooth communication circuit to establish a connection with the mobile communication device with; and
executing via the connection an access control protocol with the mobile communication device, whereby executing the access control protocol includes receiving from the mobile communication device access control data, and checking permission of the user to access the space by verifying the access control data.

In an embodiment, the processor is further configured to generate a randomized designator, by applying randomization to the designator associated with the space, and/or an encrypted designator, by encrypting the designator associated with the space, and to transmit the randomized and/or encrypted designator to a remote server.

In an embodiment, the processor is further configured to direct the Bluetooth communication circuit to operate intermittently in a broadcaster role, to make the access control device function as a beacon, transmitting advertising packets without allowing connections.

In an embodiment, the advertising packet further comprises operation information associated with the access control device transmitting the advertising packet. The operation information comprises for example power mode status data of the access control device, battery status data of the access control device, status information of a lock or a space associated with the access control device, usage information of the access control device and/or further information of the access control device.

In an embodiment, the mobile communication device receiving the advertising packet is configured to further use the operation information received in the advertising packet for determining whether the access control device is relevant for the user. The operation information may comprise information, which is used by the mobile communication device for determining whether the access control device is relevant for the user. For example, the operation information may be used to prioritize the received designators and thereby the access control devices respectively. For example, the access control devices, which are in sleep mode or which are in low battery mode may be prioritized with respect to access control devices, which are not in sleep mode or which are not in low battery mode.

In an embodiment, the mobile communication device receiving the advertising packet is configured to establish the connection between the Bluetooth communication circuit of the mobile communication device and the Bluetooth communication circuit of the access control device further using the received operation information. For example, properties for establishing the Bluetooth connection e.g. timeout parameters, are set in dependence of the received operation information. In case the received operation information comprises information indicating that the respective access control device is for example in sleep mode or is in a low battery mode, timeout parameters for the connection may be adjusted/extended automatically because of this operational information. An adjusted timeout parameter may improve establishing the connection, for example by giving the access control device enough time to wake up and respond. Further, the number of cycles for trying to establish the connection may be set in dependence of the received operation information of the respective access control device.

In an embodiment, the mobile communication device receiving the advertising packet is configured to display at least part of the received operation information to the user. For example, the mobile communication device may display that the respective access control device is in sleep mode, has a low running battery or has been used (by another user) previously (within a predefined timespan). Further, the received operation information may comprise information about whether the access control device is locked or open, which may be displayed by the mobile communication device to the user. Further, the received operation information may comprise information on one or multiple previous users of the access control device, which may be displayed by the mobile communication device to the user, preferably if the user has respective rights to see this kind of information, in particular if privacy requirements require restrictive handling of such usage information.

In an embodiment, the operation information is included in the advertising packet in a separate data segment, for example adjacent to the designator. In another embodiment, the operation information is included in the advertising packet within the designator. In an embodiment, the operation information is extracted by the mobile communication device, in particular by the processor of the mobile communication device.

In an embodiment, the operation information is accessible and adaptable using specific access right data related to operation information. Likewise, the designator may be accessible and adaptable using specific designator access right data. It is preferred that the access right data related to operation information deviate from the designator access right data, such that for example one entity is enabled to adapt the operation information and that another entity is enabled to adapt the designator.

In a further aspect of the present disclosure, provided is a method for controlling access to a space using an access control device and a user's mobile communication device, whereby the method comprises:
the access control device operating a Bluetooth communication circuit of the access control device in a peripheral role and transmitting an advertising packet, the advertising packet comprising operation information associated with the access control device transmitting the advertising packet;
the mobile communication device operating a Bluetooth communication circuit of the mobile communication device in a central role and receiving the advertising packet; and the mobile communication device displaying to the user at least part of the operation information received in the advertising packet and/or the mobile communication device transmitting to a remote server at least part of the operation information received in the advertising packet, preferably transmitting randomized and/or encrypted.

In a further aspect of the present disclosure, provided is a mobile communication device which comprises a Bluetooth communication circuit and a processor connected to the Bluetooth communication circuit, the processor being configured to perform the following steps:
operating the Bluetooth communication circuit in a central role and receiving an advertising packet from an access control device controlling access to a space;
extracting from the advertising packet operation information associated with the access control device transmitting the advertising packet; and
displaying to a user of the mobile communication device at least part of the operation information received in the advertising packet and/or transmitting to a remote server at least part of the operation information received in the advertising packet, preferably transmitting randomized and/or encrypted.

In a further aspect of the present disclosure, provided is a computer program product comprising a non-transitory computer readable medium having stored thereon computer program code configured to direct a processor of a mobile communication device to perform the following steps:
operating the Bluetooth communication circuit in a central role and receiving an advertising packet from an access control device controlling access to a space;
extracting from the advertising packet operation information associated with the access control device transmitting the advertising packet; and
displaying to a user of the mobile communication device at least part of the operation information received in the advertising packet and/or transmitting to a remote server at least part of the operation information received in the advertising packet, preferably transmitting randomized and/or encrypted.

In a further aspect of the present disclosure, provided is an access control device for controlling access to a space, the access control device comprising a Bluetooth communication circuit and a processor connected to the Bluetooth communication circuit, the processor being configured to operate the Bluetooth communication circuit in a peripheral role, to generate an advertising packet, the advertising packet comprising operation information associated with the access control device, and to transmit the advertising packet with the operation information, enabling a mobile communication device receiving the advertising packet to display to a user of the mobile communication device at least part of the operation information included in the advertising packet.

The operation information associated with the access control device is indicative of at least one of: an operational status of the access control device, an operational status of components of the access control device, an operational parameter of the access control device, an operational parameter of components of the access control device, or operating data logged by the access control device. For example, in addition to the Bluetooth communication circuit and the processor, components of the access control device may include a lock and a battery. Accordingly, the operational status of the access control device or of components of the access control device may include a battery level, e.g. a charge percentage, a locking state, e.g. open or closed, a processor state, e.g. standby or active; operational parameters of the access control device or components of the access control device may include timeout parameters, e.g. communication timeout parameters, time periods or frequencies, e.g. polling or advertising frequency, threshold levels, e.g. a minimum battery threshold level; and logged operating data may include the number and/or timing of lock opening/closing operations, the number and/or timing of battery recharges, the duration of operating states or modes, the number of successful and/or failed connection attempts.

### BRIEF DESCRIPTION OF THE DRAWINGS

The present disclosure will be explained in more detail, by way of example, with reference to the drawings in which:

FIG. 1: shows a drawing illustrating schematically a mobile communication device and an access control device associated with a space according to an exemplary embodiment;

FIG. 2: shows a drawing illustrating schematically a mobile communication device and a plurality of access control devices, each associated with a specific space according to an exemplary embodiment;

FIG. 3: shows a flow diagram illustrating schematically a plurality of steps performed by a mobile communication device and by an access control device for controlling access to a space according to an exemplary embodiment;

FIG. 4: shows a first exemplary embodiment of a step for selecting an access control device of FIG. 3;

FIG. 5: shows a second exemplary embodiment of the step for selecting the access control device of FIG. 3;

FIG. 6: shows a third exemplary embodiment of the step for selecting the access control device of FIG. 3;

FIG. 7: shows a fourth exemplary embodiment of the step for selecting the access control device of FIG. 3;

FIG. 8: shows a flow diagram illustrating schematically a plurality of steps performed by a mobile communication device, by an access control device, and by a remote server for storing a randomized and/or encrypted designator according to an exemplary embodiment;

FIG. 9: shows a flow diagram illustrating schematically a plurality of steps performed by an access control device and by a remote server for synchronizing a randomization of the designator according to an exemplary embodiment;

FIG. 10: shows a flow diagram illustrating schematically a plurality of steps performed by a mobile communication device, by an access control device and by a remote server for randomizing the designator according to an exemplary embodiment;

FIG. 11 shows possible structures of the advertisement packet according to exemplary embodiments.

### DETAILED DESCRIPTION OF THE EMBODIMENTS

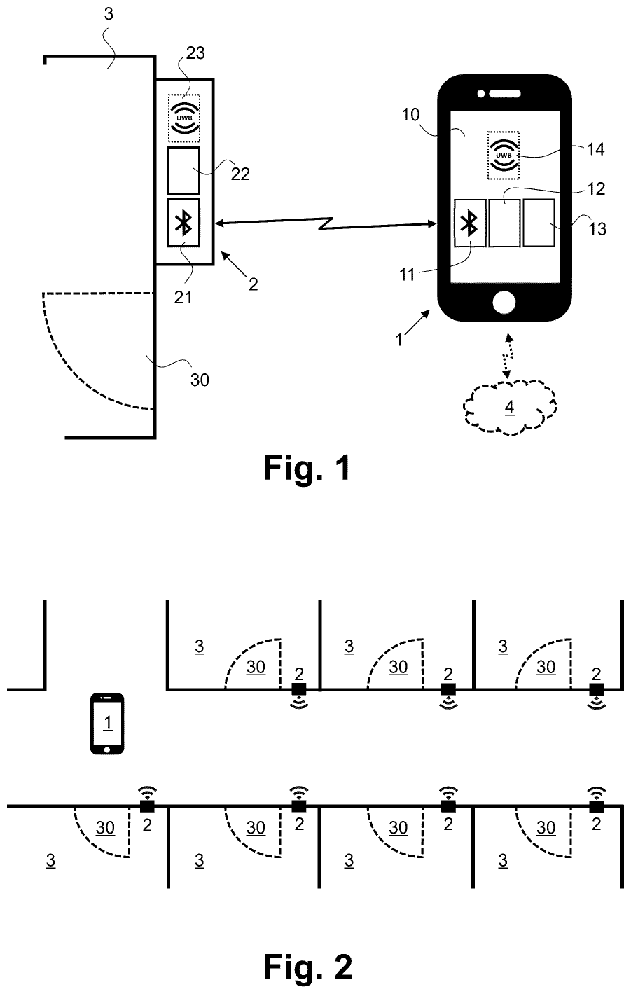

FIG. 1 shows schematically a mobile communication device 1, an access control device 2, and a space 3. The mobile communication device 1, which is, for example a smart phone, a handheld device or a wearable device, comprises a display 10 which is configured to display data and/or information to a user of the mobile communication device 1. The mobile communication device 1 further comprises a Bluetooth communication circuit 11, which is configured to transmit data to other devices and which is configured to receive data from other devices. In an embodiment, the mobile communication device 1 further comprises an ultra-wide-band (UWB) transceiver 14, which is configured to determine position or distance information based on received signal data from a UWB transceiver 23. The mobile communication device 1 further comprises a processor 12 which is configured to execute computer program code to control the mobile communication device 1. The mobile communication device 1 further comprises a non-transitory computer readable medium 13 having stored there on the computer program code configured to direct the processor 12 of the mobile communication device 1.

The access control device 2 comprises a Bluetooth communication circuit 21 and a processor 22. In an embodiment, the access control device 2 further comprises a UWB transceiver 23. The Bluetooth communication circuit 21 is configured to transmit data to other devices and is configured to receive data from other devices. The Bluetooth communication circuit 11 of the mobile communication device 1 is configured to establish a Bluetooth communication with the Bluetooth communication circuit 21 of the access control device 2. The Bluetooth communication circuit 21 of the access control device 2 is in an embodiment also configured to function as a beacon operating the Bluetooth communication circuit 21 in a broadcaster role, transmitting data without allowing connections. The processor 22 of the access control device 2 is configured to execute computer program code to control the access control device 2 to control the Bluetooth communication circuit 21 or to control the access to the space 3.

The processor 12 of the mobile communication device 1 and the processor 22 of the access control device 2 may comprise a central processing unit (CPU) for executing computer program code stored in the non-transitory computer readable medium. The processor 12 of the mobile communication device 1 and/or the processor 22 of the access control device 2 may also include more specific processing units, such as application-specific integrated circuits (ASICs), reprogrammable processing units such as field programmable gate arrays (FPGAs), or processing units specifically configured to accelerate certain applications, such as cryptographic accelerators for accelerating cryptographic functions.

The processor 12 of the mobile medication device 1 and the processor 22 of the access control device 2 are configured to control the data flow between the Bluetooth communication circuit 11 of the mobile communication device 1 and the Bluetooth communication circuit 21 of the access control device 2. The processor 12 of the mobile communication device 1 and the processor 22 of the access control device 2 are further configured to process the received data and to control the mobile communication device 1 and the access control device 2 accordingly.

The access control device 2 shown in FIG. 1 is associated with a space 3. The space 3 comprises a door 30 which is configured to enable or prevent access to the space 3. This space 3 is, for example, a specific room in a building, for example, a specific hotel room or a specific floor in a building. The access control device 2 is configured to interact with the door 30 in a manner to enable access or inhibit access via the door 30. The access control device 2 is, for example, interconnected with a lock of the door 30 wherein the access control device 2 is configured to open the lock of the door 30 and thereby allowing access to the space 3.

FIG. 1 further shows schematically a remote server 4. The remote server 4 is in an embodiment a cloud server. In an embodiment, the mobile communication device 1 is configured to receive access right data from the remote server 4. For example, the access right data includes one or more designators of rooms for which the user has an authorized access right. In this case, the remote server 4 transmits, via a communication network, the access right data to the mobile communication device 1. In this embodiment, the remote server 4 is used as a database for the access right data. The communication network uses, for example, a mobile data network, such as Global System for Mobile Communication (GSM), Code Division Multiple Access (CDMA), or Long Term Evolution (LTE) networks, and/or a close range wireless communication interface using a Wi-Fi network (WLAN), Bluetooth, and/or other wireless network types and standards.

FIG. 2 shows schematically a plurality of spaces 3 and one mobile communication device 1. Each of the spaces 3 comprises a door 30 and a specific access control device 2, which is configured to enable or inhibit access to the space 3 via the door 30. As shown in FIG. 2, the mobile communication device 1 is arranged in a common floor area or in a common floor, which leads to the different doors 30 for entering the spaces 3. The mobile communication device 1 is configured to interact with the different access control devices 2 for controlling the access to the spaces 3. The scenario shown in FIG. 2 is, for example, a building, which comprises the plurality of spaces 3, the building is, for example, a hotel and the spaces 3 are, for example, hotel rooms.

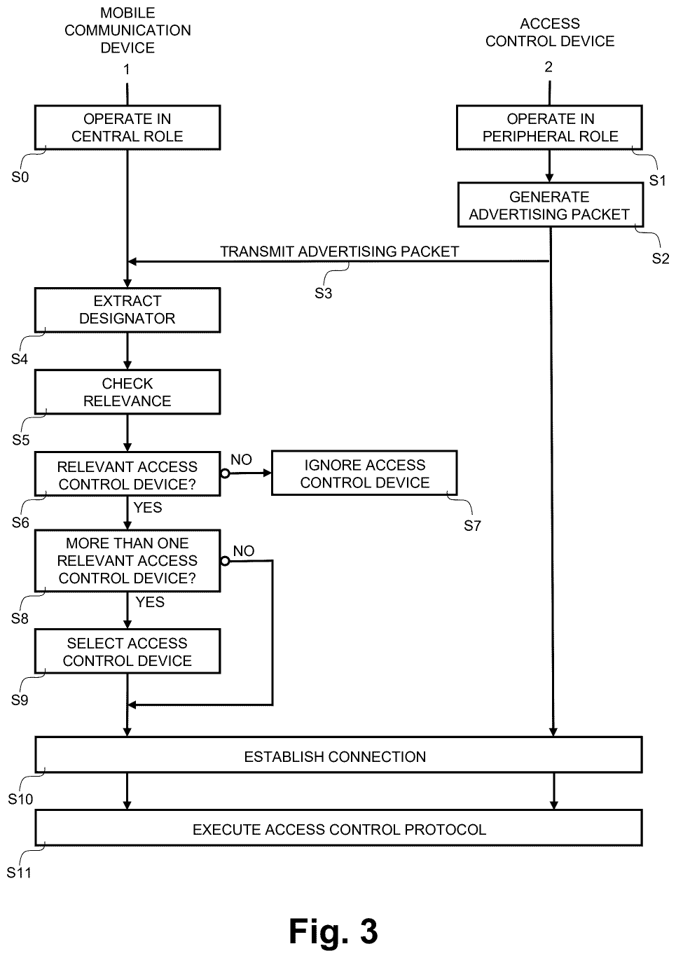

FIG. 3 shows a flow diagram illustrating a sequence of steps for controlling access to the space 3, as illustrated, for example, in FIG. 1. In the following paragraphs, described with reference to FIG. 3 is a possible sequence of steps, performed by the mobile communication device 1 and/or the access control device 2 for controlling access to the space 3.

In step S0, the mobile communication device 1 operates the Bluetooth communication circuit 11 of the mobile communication device 1 in a central role. In other words, the Bluetooth communication circuit 11 of the mobile communication device 1 is active and ready to receive and/or transmit data via the Bluetooth communication circuit 11 in the central role.

In step S1, the access control device 2 or its processor 22, respectively, operates the Bluetooth communication circuit 21 of the access control device 2 in a peripheral role. In other words, the Bluetooth communication circuit 21 of the access control device 2 is active and ready to receive and/or transmit data via the Bluetooth communication circuit 21 in the peripheral role.

Devices that implement the central role in Bluetooth communication perform a number of common tasks—for example, discovering and connecting to available peripherals, and exploring and interacting with data from peripherals. Devices that implement the peripheral role also perform a number of common, but different, tasks—for example, publishing and advertising services, and responding to read, write, and subscription requests from connected devices in central role. The terms central role and peripheral role are used in the context of the Bluetooth Low Energy standard.

In step S2, the access control device 2 or its processor 22, respectively, generates an advertising packet. The advertising packet comprises a designator which is associated with a specific space 3. In other words, each of the available spaces 3 has its own associated designator which identifies each of the spaces 3 uniquely. The designator is therefore a unique identifier for each of the spaces 3. The designator 2 may change over time, but is still associated with the specific space 3 and can therefore identify the space 3 uniquely. The advertising packet may comprise operation information associated with the access control device 2 transmitting the advertisement packet. The operation information may be included in the advertising packet in a specific data package or in a data segment, in particular adjacent to the designator, or are included in the advertising packet within the designator itself. The operation information is associated with the access control device 2 and comprises information of the access control device 2. Such information may include power mode information of the access control device 2, battery status information of the access control device 2, status information of a lock or a room associated with the access control device 2, usage information of the access control device 2 and or further information of the access control device or the associated space 3.

In step S3, the access control device 2 or its processor 22, respectively, transmits the advertising packet to the mobile communication device 1. The advertising packet, including the designator associated with the space 3 and/or the operation information associated with the access control device 2, is transmitted via the Bluetooth communication circuit 21 of the access control device 2 to the mobile communication device 1. During this step, the Bluetooth communication circuit 21 of the access control device 2 operates in the peripheral role and the Bluetooth communication circuit 11 of the mobile communication device 1 operate in the central role.

In step S4, the mobile communication device 1 or its processor 12, respectively, extracts the designator and/or the operation information from the advertising packet, received in step S3 from the access control device 2. For example, the designator is stored encrypted and/or randomized in the advertising packet and/or the operation information is stored encrypted and/or randomized in the advertising packet. The processor 12 of the mobile communication device 1, the mobile communication device 1 or an application running on the mobile communication device 1 is configured to extract and, if necessary, decrypt the designator and/or the operation information in the advertising packet. The advertising packet, in particular the designator and/or the operation information is/are for example symmetrically or asymmetrically encrypted.

In step S5, the mobile communication device 1 or its processor 12, respectively, determines whether the access control device 2 is relevant for the user of the mobile communication device 1, using the designator and the access right data stored in the mobile communication device 1. In other words, the mobile communication device 1, in particular the processor 12 of the mobile communication device 1, determines by, for example, comparing the designator with the stored access right data, if the access control device 2 is relevant for the user. For example, the stored access right data on the mobile communication device 1 of the user enable the user to access a specific space 3. The designator received from the access control device 2 is compared to the stored access right data by the processor 12 of the mobile communication device 1 for determining whether the access control device 2 associated with the specific room 3 is relevant for the user of the mobile communication device 1. The access right data is, for example, received from the remote server 4 via the communication network by the mobile communication device 1. In step S5, the mobile communication device 1 or its processor 12, respectively, may determine whether the access control device 2 is relevant for the user of the mobile communication device 1, further using the operation information extracted from the received advertising packet. For example, the received operation information of the different access control devices 2 may be used to determine an order or sequence, in which the received designators are compared with the access right data. In other words, the operation information of the different access control devices may be used for determining a prioritisation for comparing the received designators with the access right data.

As illustrated in step S6 of FIG. 3, when the mobile communication device 1 or its processor 12, respectively, determines that the access control device 2 is relevant for the user of the mobile communication device 1, processing continues in step S8. Otherwise, if the access control device 2 is not relevant for the user of the mobile communication device 1, processing continues in step S7 and this specific access control device 2 is ignored. In an embodiment, the user of the mobile communication device 1 does not even notice that these steps have been performed on his mobile communication device 1 and in particular that this specific access control device 2 is ignored by the mobile communication device 1. This helps to avoid any unnecessary distractions of the user by the mobile communication device 1. In another embodiment, the mobile communication device 1 shows to its user, if the specific access control device 2 is relevant. In this case, the user may receive a valuable information regarding the relevant access control devices 2. The mobile communication device 1 may be configured to show to the user the specific relevant access control device 2 using received operation information. For example, the relevant access control device 2 is in sleep mode, which is included in the received operation information. This might be shown to the user, for example by a corresponding icon or text, which tells the user that the respective as relevant identified access control device 2 is in sleep mode or is running on low battery. Other operation information, like the last access time of the as relevant identified access control device 2 may also be displayed respectively to the user. The displayed information may vary in dependence of the access right data stored on the user's mobile communication device. For example, one user has access right data enabling access to the respective space, another user has access right data enabling access to the respective space and enabling that the specific operation information is displayed to the user.

As illustrated in step S8 of FIG. 3, when the mobile communication device 1 or its processor 12, respectively, determines that more than one access control device 2 is relevant for the user, processing continues in step S9; otherwise processing for the one relevant access control device 2 continues in step S10. For example, the mobile communication device 1 receives from a plurality of access control device 2 advertising packets, each comprising a designator associated with a specific room 3 and/or each comprising the operation information associated with the access control device 2. This scenario may occur when the mobile communication device 1 is located, for example, in a hotel floor as shown in FIG. 2. In this case, all of the access control devices 2 transmit their advertising packet comprising the unique designator associated with the respective spaces 3 and/or the operation information associated with the access control device 2. A hotel guest, which has booked a plurality of rooms/spaces 3, has on his mobile communication device 1 access right data enabling access to the plurality of booked rooms. The relevance check performed in step S5 for the extracted designators received from more than one access control devices 2 will be affirmative, i.e. more than one access control device 2 is determined relevant for the user. The mobile communication device 1 may be configured to show to the user the specific plurality of relevant access control device 2 using received operation information of the plurality of the relevant access control devices. For example, a plurality of relevant access control device 2 may be in sleep mode, which is included in the received operation information. This might be shown to the user, for example by a corresponding icon or text, which tells the user that the respective plurality as relevant identified access control device 2 is in sleep mode or is running on low battery. Other operation information, like the last access time of the as relevant identified access control device 2 may also be displayed respectively to the user, preferably only if the user's mobile communication device has stored the respective rights, enabling to see such information.

In another scenario, a hotel guest, which has booked only a single room, has on his mobile communication device 1 only a single access right data stored, enabling the access only to his booked room. The relevance check performed in step S5 for the plurality of extracted designators received from several access control devices 2 will be affirmative only for the designator associated with the booked room, i.e. only the access control devices 2 of the booked room is relevant for this user.

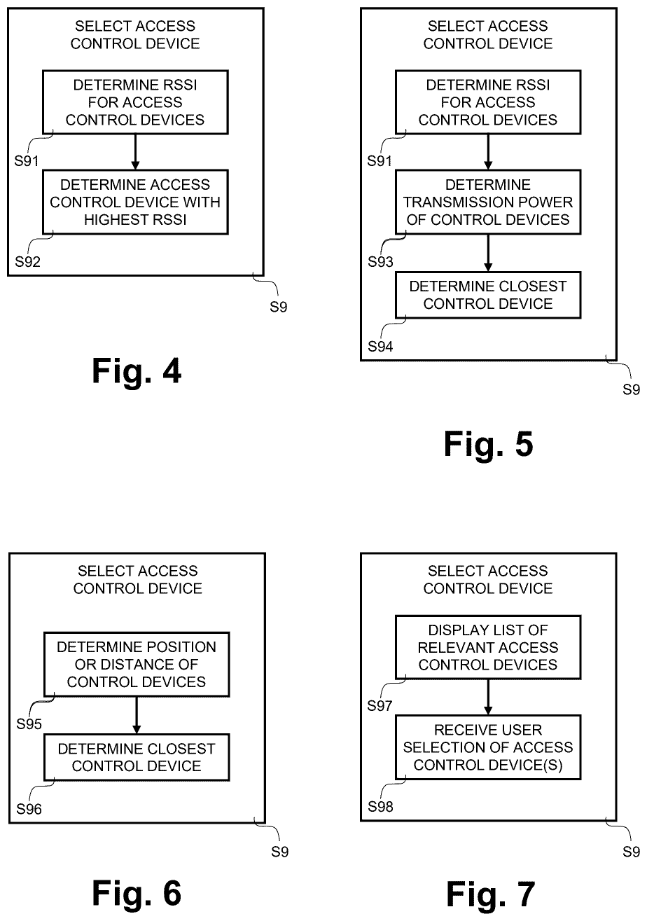

In step S9, a selected access control device 2 is determined from the plurality of relevant access control devices 2, as determined in steps S6 and S8. In other words, the mobile communication device 1 and/or the user of the mobile communication device 1 make(s) a selection from the different relevant access control devices 2, as described later with reference to FIGS. 4, 5, 6 and 7. In step S9, the selected access control device 2 may be determined from the plurality of relevant access control device 2 further using the operation information. For example, the operation information may be used to sort and/or prioritize the as relevant determined access control device 2, which is displayed in the respective (prioritized) order.

In step S10, the mobile communication device 1 and the (selected) relevant access control device 2, establish a connection between the Bluetooth communication circuit 11 of the mobile communication device 1 and the Bluetooth communication circuit 21 of the access control device 2. The established Bluetooth connection makes it possible to exchange data between the mobile communication device 1 and the access control device 2. In step S10, the mobile communication device 1 and the (selected) relevant access control device 2, may establish the connection between the Bluetooth communication circuit 11 of the mobile communication device 1 and the Bluetooth communication circuit 21 of the access control device 2 further using the operation information received from the respective (selected) relevant access control device 2. For example, the respective (selected) relevant access control device 2 is in sleep mode, which is transmitted by the operation information to the mobile communication device 1. This information is used by the mobile communication device 1, in particular by its processor, to set parameters for the connection. For example, timeout parameters or the number of connection attempts, is set in dependence of the respective received operation information. In case the respective access control device 2 is in sleep mode, the timeout parameter for establishing the Bluetooth connection is extended.

In step S11, the mobile communication device 1 and the access control device 2 execute an access control protocol via the connection established in step S10. Executing the access control protocol includes the mobile communication device 1 transmitting access control data to the access control device 2, and the access control device 2 checking permission of the user to access the space 3 by verifying the access control data from the mobile communication device 1. The person skilled in the art will understand that different kinds of access control protocols can be implemented and executed via the established connection. For example, the access control data comprises one or more access keys, access rights, access times, and the like, as required by the particular access control protocol used. In step S11, the mobile communication device 1 and the access control device 2 may execute the access control protocol via the connection established in step S10 using the transmitted operation information.

The access control protocol is according to the present disclosure only executed, if the relevance check, as described with reference to step S5, determines that the specific access control device 2 is relevant for the user. In other words, the access control protocol is only executed once and not all the time when one or a plurality of access control devices 2 is within communication range of the Bluetooth communication circuit 11 of the mobile communication device 1. The different access control device 2 are filtered, using the different advertising packets with the included designator, transmitted from the access control device 2 to the mobile communication device 1, and the access right data stored in the mobile communication device 1. In case more than one access control device 2 is relevant, the mobile communication device 1 itself or the user of the mobile communication device 1 makes a selection, preferably with the usage of the respective operation information, and determines thereby the selected access control device 2 with which the connection is established and with which the access control protocol is executed. The access control protocol is therefore far less times executed compared to conventional systems, which do not filter the different access control devices 2. This saves time and energy compared to the conventional systems. In addition, according to the present disclosure, it is not required that the mobile communication device 1 establishes a Bluetooth connection with all of the possible access control devices 2 which are in (communication) range of the Bluetooth communication circuit 11 of the mobile communication device 1 which also safes energy and time. In addition, no interaction by the user with the mobile communication device 1 is required to get access to the right space 3, which advantageously increases the usability, in particular for elderly and very young people. For example, the user of the mobile communication device 1 does only need to stand in front of the door 30 associated with the space 3 where he has access rights and the door 30, in particular the access control device 2, will automatically enable access, without any interaction.

FIG. 4 shows a first exemplary embodiment of step S9 of FIG. 3 for selecting an access control device 2.

As shown in FIG. 4, the selected access control device 2 is determined by the mobile communication device 1 or its processor 12, respectively, using received signal strength indication (RSSI) of the relevant access control devices 2. RSSI determines the signal strength of the received signal.

In step S91, the mobile communication device 1 determines the RSSI for the plurality of access control devices 2, which were determined relevant for the user of the mobile communication device 1. Typically, the closer the relevant access control device 2 is to the mobile communication device 1, the higher is the rating of this access control device 2.

In step S92, the mobile communication device 1, determines the selected access control device 2 having the highest RSSI. In other words, the closest relevant access control device 2 to the mobile communication device 1, having likely the highest RSSI is determined as the selected access control device 2.

According to this embodiment, the relevant access control device 2 having the highest RSSI is automatically determined as the selected access control device 2 without any interaction of the user. For example, a user of the mobile communication device 1 has access right data stored for two spaces 3. The second of those two spaces 3 is located within the first of the two spaces 3, for example, the first access right data enable access to a specific floor of a building and the second access right data enable access to a specific room located in the specific floor. The user getting close to the floor and the room may already receive the advertising packets from the floor and from the room. In this case, it is helpful to determine the selected access control device 2 from the relevant access control devices 2 using the highest RSSI. The access control device 2 associated with the floor and the mobile communication device 1 execute the access control protocol prior to the access control device 2 associated with the room and the mobile communication device 1 executing the access control protocol. The room remains closed until the user has entered the floor. According to this embodiment, it is possible to reduce the probability that the access control protocol is executed with an undesired access control device 2.

FIG. 5 shows a second exemplary embodiment of step S9 of FIG. 3 for selecting an access control device 2.

As shown in FIG. 5, the selected access control device 2 is determined by the mobile communication device 1 or its processor 12, respectively, further using the transmission power of the relevant access control devices 2. In step S93, the mobile communication device 1 or its processor 12, respectively, determines the transmission power levels of the relevant access control devices 2. The transmission power level, also known as TX power, determines how powerful a signal is transmitted. The transmission power level is proportional to an effective range of a signal. The transmission power level influences the RSSI of a received signal. For example, two signal sources may have different transmission power levels, one has a high transmission power level and the other has a low transmission power level.

In step S94, the mobile communication device 1 or its processor 12, respectively, determines the closest access control device 2 of the different relevant access control devices 2 using the determined RSSI and the determined transmission power levels. By taking into account the transmission power levels of the signal sources it is advantageously possible to increase the accuracy of the determination of the closest access control device 2 to the mobile communication device 1.

FIG. 6 shows a third exemplary embodiment of step S9 of FIG. 3 for selecting an access control device 2. As shown in FIG. 6, the selected access control device 2 is determined by the mobile communication device 1 or its processor 12, respectively, using position or distance data of the relevant access control devices 2.

In step S95, the mobile communication device 1 determines a position of the relevant access control devices 2 or a distance of the relevant access control devices 2 to the mobile communication device 1 using the ultra-wide-band (UWB) transceiver 14. UWB technology is used for real-time position tracking of the mobile communication device 1 with respect to the relevant access control devices 2. The precision capabilities of UWB and low power requirements make the UWB technology well-suited for radio-frequency-sensitive environments, such as hospitals. The different signals from the UWB transceivers 23 of the different relevant access control devices 2 are, for example, received and analyzed by the processor 12 of the mobile communication device 1 using the UWB transceiver 14. Further, the different relevant access control devices 2 are sorted (ranked) with respect to the distance to the mobile communication device 1. It is therefore possible to create a sorted list of the relevant access control devices 2 in dependence on the position of the access control devices 2 with respect to the mobile communication device 1 or the distance between the access control devices 2 and the mobile communication device 1.

In step S96, the mobile communication device 1 determines the closest access control device 2 as selected access control device 2 using the position or distance information determined in step S95, as described above.

Using the UWB technology allows advantageously to increase the accuracy of the determination of the closest relevant access control device 2 and offers an additional possibility to determine the closest relevant access control device 2. A combination of the RSSI technology, the transmission power technology and the UWB technology is also conceivable.

FIG. 7 shows a fourth exemplary embodiment of step S9 of FIG. 3 for selecting an access control device 2. As shown in FIG. 7, the selected access control device 2 is determined by the mobile communication device 1 or its processor 12, respectively, using feedback from the user of the mobile communication device 1.

In step S97, the mobile communication device 1 or its processor 12, respectively, displays a list of the determined relevant access control devices 2 on its display 10.

In step S98, the mobile communication device 1 receives a user selection of the selected access control device 2. In other words, the user selects on the display 10 of the mobile communication device 1 using, for example a touch screen or keyboard user interface, the selected access control device 2 from the presented list of relevant access control devices 2. The mobile communication device 1, in particular the processor 12 of the mobile communication device 1, receives the user selection. The presented list may be sorted/ranked/prioritized based on determined distance information between the respective access control devices 2 and the mobile communication device 1, for example, the closest relevant access control device 2 is presented first in the list.

In an embodiment, the access control protocol is only executed, if the mobile communication device 1 is located within a predefined distance to the selected access control device 2. In other words, the access control protocol is only executed when the mobile communication device 2 is located near enough to the selected access control device 2. According to this embodiment, the user carrying the mobile communication device 1 has to be positioned within a predefined distance of the selected access control device 2 for the execution of the access control protocol. The predefined distance between the mobile communication device 1 and the selected access control device 2 is, for example, equal or less than five meters, preferably equal or less than three meters, more preferably equal or less than one meter. In an embodiment, the distance is determined using RSSI, transmission power and/or UWB technology. According to this embodiment, it is advantageously possible that a door 30 enables access only if the user is close to the door.

In an embodiment, the user of the mobile communication device 1 may have access right data stored for a plurality of rooms for example in a hotel or a business building. The selection of the respective access control device 2 may be performed further using the operation information comprising information of the different access control devices 2. An access control device 2, which is associated with a floor door may be prioritized compared to an access control device 2, which is associated with a room in this floor. The access control device 2 of the floor and the access control device 2 of the room are for example also as such displayed to the user, such that the user may advantageously select first the access control device 2 of the floor for connection and in a second step the access control device 2 of the room for establishing the Bluetooth connection.

In a further embodiment, selecting of the relevant access control device 2 from a plurality of relevant access control devices 2 may be performed using received operating information of access control devices 2, which comprise occupation status information of the respective access control devices 2. Occupation status information is for example information about whether the respective room is currently occupied by for example a hotel guest. The presence of the hotel guest is for example determined manually by the guest itself, by for example pressing a respective button on the access control device 2, or automatically, for example by detecting the presence of his or any mobile phone in the respective room. Other occupation determining methods are also conceivable. This varying occupation status information is transmitted in the operating information within the advertising packet to the respective mobile communication device. Further this occupation information is, for example, displayed to the user of the mobile communication device. For example cleaning personnel of the hotel may perform the selection of the access control device 2 further using this information. The Bluetooth connection may only be established with non-occupied rooms. It is also conceivable that the operating information may inhibit that the connection can be established. For example, a connection with an occupied room cannot be established, even if the mobile communication device may comprise access right data which enable access (in an unoccupied status of the room). In another embodiment, maintenance personnel of the hotel or the building may perform the selection of the access control device 2 further using the operation information, which show that the respective access control device 2 needs maintenance, for example a battery switch.

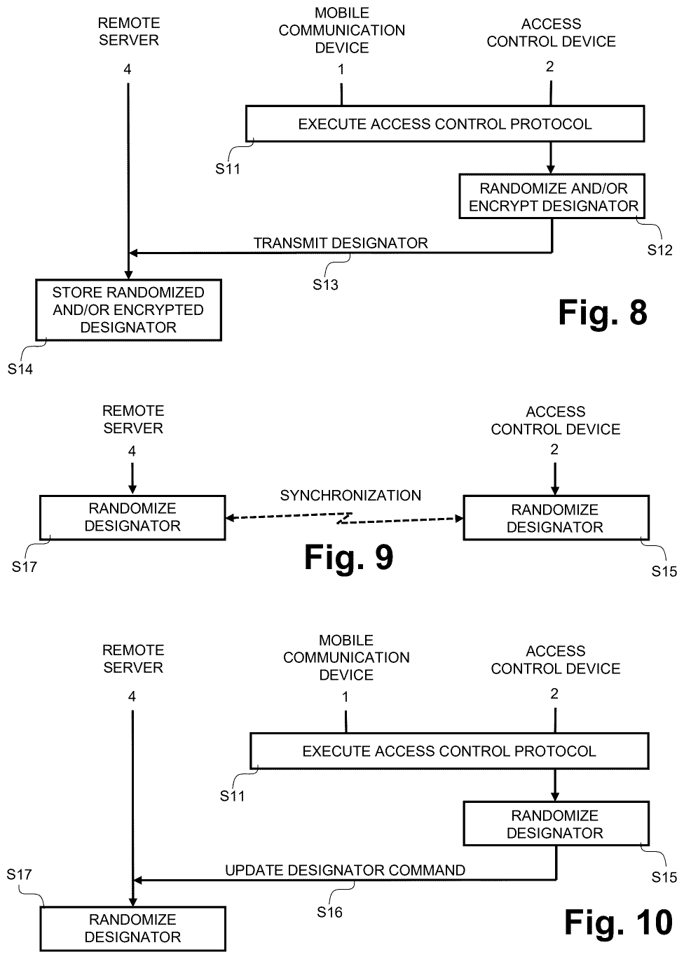

FIG. 8 shows a flow diagram illustrating schematically a plurality of steps performed by a mobile communication device 1, by an access control device 2 and by the remote server 4 for generating and storing a randomized and/or encrypted designator according to an exemplary embodiment.

In step S12, subsequent to executing the access control protocol in step S11, as described in connection with FIG. 3, the access control device 2 randomizes and/or encrypts the designator. Randomizing and/or encrypting may be necessary, because otherwise it may be possible to determine, by a third party, using the designator, which user used which space 3 during which time period, as may be prohibited by data protection compliance rules. Randomizing includes amending the designator or at least parts of the designator such that sensitive information about a user's location and movement can no longer be derived from the designator. In an embodiment, the processor 22 of the access control device 2 randomizes the designator. Encryption is used to keep sensitive information included in the designator safe from an unwanted third party access. The sensitive information includes, for example, information about which designator is associated with which space 3.

In step S13, the randomized and/or encrypted designator is transmitted from the access control device 2 to the remote server 4. In an embodiment, the mobile communication device 1 is used for transmitting of the randomized and/or encrypted designator to the remote server 4. In particular, the processor 12 of the mobile communication device 1 is configured to receive from the access control device 2 the randomized and/or encrypted designator associated with the space 3, and to transmit the randomized and/or encrypted designator securely via a communication network to the remote server 4. In step S13, the operation information may be transmitted from the access control device 2 to the remote server 4, in particular randomized and/or encrypted. The mobile communication device 1 may also be used for the transmission securely via the communication network to the remote server 4.

In step S14, the remote server 4 stores the randomized and/or encrypted designator received from the access control device 2. In this embodiment, the remote server 4 is used as a database of the different designators associated with the different spaces 3. It is for example required that the designator is amended after a predefined time period or after a predefined number of usages. In this case, the access control device 2 randomizes and/or encrypts a new designator. This designator is transmitted via the mobile communication device 1 to the remote server 4. Here this designator is stored and transmitted to a new mobile communication device 1 as access right data. In step S14, the remote server 4 may store the operation information received from the access control device 2. The remote server 4 for the designator may deviate from the remote server 4 of the operation information. Different entities may control the different remote servers. For example, the operator of the building/space 3 may control the system for the designator and the operator or the manufacturer of the access control device 2, may control the system for the operation information.

In case an old designator is stored in the remote server 4, the newly received randomized and/or encrypted designator replaces the old designator.

FIG. 9 shows a flow diagram illustrating schematically a synchronized randomization of the designator both at the access control device 2 and the remote server 4 according to an exemplary embodiment. By way of the synchronized randomization, the designator is randomized in the same fashion, e.g. using the same randomization algorithm, at synchronized times, so that both the access control device 2 and the remote server 4 are provided and use the same randomized designator at the same time, without requiring any communication of the randomized designator between the access control device 2 and the remote server 4.

In step S15, synchronized with step S17, the access control device 2 or its processor 22, respectively, randomizes the designator stored in the access control device 2.

In step S17, synchronized with step S15, the remote server 4 randomizes the designator stored in the remote server 4.

As indicated schematically indicated in FIG. 9 by the dashed arrow, the randomization by the access control device 2 and the randomization by the remote server 4 are synchronized. For example, the randomizations take place at the same time based on synchronized clocks.

The synchronization of the randomization is implemented, for example, by performing the randomization after a predefined time period, e.g. a predefined usage time period of the associated space 3, after a predefined number of usages, or according to another predefined mechanism, e.g. triggered by an external synchronization signal.

FIG. 10 shows a flow diagram illustrating schematically a randomization of the designators stored on the access control device 2 and on the remote server 4. FIG. 10 represents a possible embodiment of the synchronization of the randomization of designators as shown in FIG. 9. The steps S15 and S17 of FIG. 10 correspond to the steps S15 and S17 of FIG. 9.

As illustrated in FIG. 10, in step S16, an update designator command is transmitted from the access control device 2 to the remote server 4. This command triggers the randomization of the designator stored in the remote server 4. In an embodiment, the command is transmitted via the mobile communication device 1.

For example, the randomization of the designator associated with a specific space 3 stored in the access control device 2 is executed after the execution of the access control protocol in step S11. This triggers, according to the embodiment of FIG. 10, the transmission of the update designator command to the remote server 4. After receiving the update command, the remote server 4 randomizes in step S17 the designator associated with the specific space 3. As explained in connection with FIG. 9, both the access control device 2 and the remote server 4 are provided and use the same randomized designator, without requiring any communication of the randomized designator between the access control device 2 and the remote server 4.

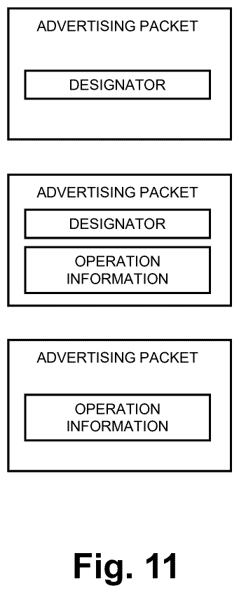

FIG. 11 shows different possible structures of the advertisement packet. The top portion of FIG. 11 shows the advertisement packet according to a first embodiment, comprising the designator. According to this embodiment, the designator may additionally comprise operation information. The middle portion of FIG. 11 shows the advertisement packet according to a second embodiment comprising the designator and the operation information as separate data segments within the advertising package. The bottom portion of FIG. 11 shows the advertisement packet according to a further aspect comprising the operation information within the advertising package.

It should be noted that, in the description, the sequence of the steps has been presented in a specific order, one skilled in the art will understand, however, that the order of at least some of the steps could be altered, without deviating from the scope of the disclosure.

1. A method of controlling access to a space using an access control device and a user's mobile communication device, the method comprising:
the access control device operating a Bluetooth communication circuit of the access control device in a peripheral role and transmitting an advertising packet, the advertising packet comprising a designator associated with the space;
the mobile communication device operating a Bluetooth communication circuit of the mobile communication device in a central role and receiving the advertising packet;
the mobile communication device determining whether the access control device is relevant for the user, using the designator, received in the advertising packet, and access right data stored in the mobile communication device;
the mobile communication device, upon determining that the access control device is relevant for the user, establishing a connection between the Bluetooth communication circuit of the mobile communication device and the Bluetooth communication circuit of the access control device; and
the mobile communication device and the access control device executing an access control protocol via the connection, executing the access control protocol including the mobile communication device transmitting access control data to the access control device, and the access control device checking permission of the user to access the space by verifying the access control data from the mobile communication device.

2. The method of claim 1, wherein the mobile communication device receives advertising packets from a plurality of access control devices; upon determining that more than one access control device is relevant for the user, the mobile communication device determines a selected access control device, and establishes the connection with the Bluetooth communication circuit of the selected access control device.

3. The method of claim 2, wherein the mobile communication device determines the selected access control device, using received signal strength indicators determined for the relevant access control devices.

4. The method of claim 2, wherein the mobile communication device determines the selected access control device, using position or distance information, determined for the relevant access control devices by the mobile communication device using an ultra-wide-band transceiver.

5. The method of claim 2, wherein the mobile communication device determines the selected access control device by showing to the user on a display a list of the relevant access control devices, and receiving from the user a selection of the selected access control device.

6. The method of claim 1, further comprising the access control device generating at least one of: a randomized designator, by applying randomization to the designator associated with the space, or an encrypted designator, by encrypting the designator associated with the space, and transmitting the randomized and/or encrypted designator to a remote server.

7. The method of claim 6, wherein the access control device transmits the randomized and/or encrypted designator via the mobile communication device to the remote server.

8. The method of claim 1, wherein the access control device functions intermittently as a beacon operating the Bluetooth communication circuit of the access control device in a broadcaster role, transmitting advertising packets without allowing connections; and the mobile communication device shows on a display a spatial arrangement of a plurality of access control devices functioning as beacons.

9. A mobile communication device comprising a Bluetooth communication circuit and a processor connected to the Bluetooth communication circuit, the processor being configured to perform the following steps:
operating the Bluetooth communication circuit in a central role and receiving an advertising packet from an access control device controlling access to a space;
extracting from the advertising packet a designator associated with the space;
determining whether the access control device is relevant for a user of the mobile communication device, using the designator and access right data stored in the mobile communication device;
upon determining that the access control device is relevant for the user, directing the Bluetooth communication circuit to establish a connection with the access control device; and
executing an access control protocol via the connection, executing the access control protocol including the processor directing the Bluetooth communication circuit to transmit access control data to the access control device, enabling the access control device to check permission of the user to access the space.

10. The mobile communication device of claim 9, wherein the processor is configured to receive advertising packets from a plurality of access control devices; upon determining that more than one access control device is relevant for the user, determine a selected access control device, and establish the connection with the selected access control device.

11. The mobile communication device of claim 10, wherein the processor is configured to determine the selected access control device, using received signal strength indicators determined for the relevant access control devices .

12. The mobile communication device of claim 10, wherein the mobile communication device comprises an ultra-wide-band transceiver, and the processor is configured to determine for the relevant access control devices position or distance information, using the ultra-wide-band transceiver, and to determine the selected access control device, using the position or distance information.

13. The mobile communication device of claim 10, wherein the processor is configured to determine the selected access control device by showing to the user on a display a list of the relevant access control devices, and receiving from the user a selection of the selected access control device.

14. The mobile communication device of claim 9, wherein the processor is configured to receive from the access control device a randomized and/or encrypted designator associated with the space, and to transmit the randomized and/or encrypted designator securely via a mobile radio network to a remote server.

15. A computer program product comprising a non-transitory computer readable medium having stored thereon computer program code configured to direct a processor of a mobile communication device to perform the following steps:
operating a Bluetooth communication circuit of the mobile communication device in a central role and receiving an advertising packet from an access control device controlling access to a space;
extracting from the advertising packet a designator associated with the space;
determining whether the access control device is relevant for a user of the mobile communication device, using the designator and access right data stored in the mobile communication device;
upon determining that the access control device is relevant for the user, directing the Bluetooth communication circuit to establish a connection with the access control device; and
executing an access control protocol via the connection, executing the access control protocol including the processor directing the Bluetooth communication circuit to transmit access control data to the access control device, enabling the access control device to check permission of the user to access the space.

16. The computer program product of claim 15, wherein the computer program code is further configured to direct the processor to receive advertising packets from a plurality of access control devices; upon determining that more than one access control device is relevant for the user, determine a selected access control device, and establish the connection with the selected access control device.

17. The computer program product of claim 16, wherein the computer program code is further configured to direct the processor to determine the selected access control device, using received signal strength indicators determined for the relevant access control devices.

18. The computer program product of claim 16, wherein the computer program code is further configured to direct the processor to determine for the relevant access control devices position or distance information, using an ultra-wide-band transceiver of the mobile communication device, and to determine the selected access control device, using the position or distance information.

19. The computer program product of claim 16, wherein the computer program code is further configured to direct the processor to determine the selected access control device by showing to the user on a display a list of the relevant access control devices, and receiving from the user a selection of the selected access control device.

20. The computer program product of claim 15, wherein the computer program code is further configured to direct the processor to receive from the access control device a randomized and/or encrypted designator associated with the space, and to transmit the randomized and/or encrypted designator securely via a mobile radio network to a remote server.

21. An access control device for controlling access to a space, the access control device comprising a Bluetooth communication circuit and a processor connected to the Bluetooth communication circuit, the processor being configured to perform the following steps:
operating the Bluetooth communication circuit in a peripheral role and transmitting an advertising packet, the advertising packet comprising a designator associated with the space, the designator enabling a mobile communication device (receiving the advertising packet to determine whether the access control device is relevant for a user of the mobile communication device;
receiving from the mobile communication device, having determined that the access control device is relevant for the user, a connection request at the Bluetooth communication circuit and directing the Bluetooth communication circuit to establish a connection with the mobile communication device with; and
executing via the connection an access control protocol with the mobile communication device, whereby executing the access control protocol includes receiving from the mobile communication device access control data, and checking permission of the user to access the space by verifying the access control data.

22. The access control device of claim 21, wherein the processor is further configured to generate at least one of: a randomized designator, by applying randomization to the designator associated with the space, or an encrypted designator, by encrypting the designator associated with the space, and to transmit the randomized and/or encrypted designator to a remote server.

23. The access control device of claim 21, wherein the processor is further configured to direct the Bluetooth communication circuit to operate intermittently in a broadcaster role, to make the access control device function as a beacon, transmitting advertising packets without allowing connections.
